(19) United States
(12) Patent Application Publication
(10) Pub. No.: US 2017/0367301 A1
(43) Pub. Date: Dec. 28, 2017

(54) ANIMAL TRAINING AND CONTROL DEVICES

(71) Applicant: Krauser Pet Products, LLC, Bartlett, IL (US)

(72) Inventors: Carsello M. Thomas, Bartlett, IL (US); Bradley B. Braydon, Mishawaka, IN (US); Kenneth H. Kand, Elgin, IL (US)

(21) Appl. No.: 15/642,448

(22) Filed: Jul. 6, 2017

Related U.S. Application Data
(63) Continuation-in-part of application No. 15/150,380, filed on May 9, 2016, now abandoned.
Application No. 15/150,380 is a continuation of application No. 13/795,260, filed on Mar. 12, 2013, now Pat. No. 9,332,733.
(60) Provisional application No. 61/609,443, filed on Mar. 12, 2012.

(51) Int. Cl. A01K 27/00; A01K 15/00

(52) U.S. Cl. CPC A01K 27/001; A01K 15/00

(57) ABSTRACT

An animal training and control device eliminates control and training forces from being applied to the animal's tracheal region. The device may form a loop or open area around the animal's tracheal region and have a shape that distributes control forces to strategic touch points, include lateral areas of the animal's neck, the chest area and an area under the chin of the animal Stiffening elements may be provided in the neck engaging sections. Curved transitions, combined with a flexible construction, which may be unitary and molded or formed, and interaction of the stiffening elements provides a unique combination of forces applied to the strategic touch points during control of the animal and permits full range of head movement without buckling of the device. A gripping pattern may be formed into an engaging surface on the device to enhance fit and reduce movement of the device relative to the animal.

### PRIORITY CLAIM AND REFERENCE TO RELATED APPLICATIONS

This application is a continuation-in-part of and claims priority under all applicable laws, treaties and regulations, to U.S. pending application Ser. No. 15/150,380 filed on May 9, 2016 titled “ANIMAL TRAINING AND CONTROL DEVICE” which is a continuation of U.S. application Ser. No. 13/795,260, filed on Mar. 12, 2013, now U.S. Pat. No. 9,332,733. The subject matter of these documents is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

### 1. Technical Field

The disclosure relates to animal training and control devices.

### 2. Prior Art

Various types of animal training and control devices are known. Such devices are used to control and guide animals, such as dogs. The prior art is replete with collar devices or harnesses which are secured around the body and/or the neck of the dog.

The prior art suffers from a number of disadvantages, many relating to the physical impact of control devices on the animal For example, typical dog collar structures may cause physical discomfort to the animal by transferring control and pulling forces to the animal's trachea or other sensitive or vital parts of the animal's body. In addition, known collar and harness structures are often configured with the comfort and usefulness of the human owner in mind while ignoring comfort and beneficial effects on the animal.

There is thus a need for animal control and training devices which address the aforementioned shortcomings and others in the prior art including providing safety, comfort and therapeutic effects to the animal as well as improved control by those seeking to train and control the animal.

### SUMMARY

According to one aspect, a dog collar includes a member for positioning on the front of a dog. The member includes first and second sections extending along the dog's neck on opposite sides thereof. The member further includes a first end for positioning beneath the dog's lower chin and a second end for positioning adjacent the dog's chest. The first and second ends connect the first and second sections to form a closed loop having a central opening overlying the dog's trachea.

In one embodiment of the invention, the dog collar further includes a strap for positioning adjacent the back of the dog's neck. The strap has a first end connected to the first member and a second end connected to the first member.

In another embodiment of the invention, the first and second sections each include a first end and a second end. A third section extends at an angle from the first end of the first section and is connected to the first end of the member. A fourth section extends at an angle from the first end of the second section and is connected to the first end of the member. The angle in certain embodiments is between approximately 135 degrees to 140 degrees.

In another embodiment of the invention, the collar further includes a fifth section extending from the second end of the first section at an angle thereto. The fifth section is connected to the second end of the member. A sixth section extends at an angle from the second end of the second section and is connected to the second end of the member. The angle in certain embodiments of the invention is between approximately 145 degrees to 150 degrees.

According to another aspect of the disclosure, an animal training and control device is provided which eliminates control and training forces from being applied to the animal's tracheal region. The device may form a loop or open area around the animal's tracheal region and have a shape that distributes control forces to strategic touch points on the animal's body. These touch points may include lateral areas of the animal's neck, where a snug fit of the device may put slight pressure on the muscles in the lateral neck area of the animal and bring a sense of comfort, soothing and calming. Touch points may also include the chest area of the animal, typically where the animal has the largest concentration of nerves and sensitivity. Touch points may include an area under the chin of the animal, where pressure may reduce the tendency of the animal to bite or bark. According to an aspect of the disclosure, the device provides a loop construction which may include a chest-engaging section, two lateral neck engaging sections and a chin engaging section extending between the two neck engaging sections. Curved transitions between these sections, combined with a flexible construction, which may be unitary and molded or formed, provides a unique combination of forces applied to the strategic touch points during control of the animal. In addition, a gripping pattern may be formed into an engaging surface on the device to enhance fit and reduce movement of the device relative to the animal.

According to another aspect of the disclosure, an example device for animal training and control may include stiffening elements in the form of inserts made of a material, such as nylon, with increased rigidity and stiffness compared to the material from which the neck engaging sections are formed. The stiffening elements may stabilize and stiffen the neck engaging sections and improve interaction of the device with the animal. According to a related aspect, the stiffening elements may include apertures for fastening a leash or attachment system to the device.

According to another aspect of the disclosure, side shields may be provided on the device, on the neck engaging sections or other sections, for enhancing comfort and fit. The side shields may be constructed of a cloth fabric and may include a gripping pattern formed on or added to an inner surface for engaging the animal.

According to another aspect, a leash attachment system may be provided on the device and may include a strap member which forms a sliding loop that receives a leash attachment ring for sliding movement therein. The sliding movement of the attachment ring eliminates or reduces rotation or twisting of the device relative to the animal when control forces are applied to the device.

### DESCRIPTION OF THE DRAWINGS

The above and other attendant advantages and features of the invention will be apparent from the following detailed description together with the accompanying drawings, in which like reference numerals represent like elements throughout. It will be understood that the description and embodiments are intended as illustrative examples and are not intended to be limiting to the scope of invention, which is set forth in the claims appended hereto.

FIG. 1 is a perspective view of a dog collar according to one embodiment of the present invention.

FIG. 2 is a right side view of the dog collar of FIG. 1 positioned on a dog.

FIG. 3 is a top plan view of the dog collar of FIG. 1 positioned on a dog.

FIG. 4 is a right side view of the dog collar of FIG. 1 positioned on a dog.

FIG. 5 is a bottom plan view of the dog collar of FIG. 1 positioned on a dog.

FIG. 6 is a top plan view of an alternative embodiment of a dog collar according to the present invention positioned on a dog.

FIG. 7 is a front perspective view of an alternative embodiment of a dog collar according to the present invention.

FIG. 8 is a rear perspective view of the dog collar of FIG. 7.

FIG. 9 is a right side perspective view of the dog collar of FIG. 7.

FIG. 10 is a left side perspective view of the dog collar of FIG. 7.

FIG. 11 shows the dog collar of FIG. 7 positioned on a dog. FIG. 1 is a perspective view of an example grow system according to an aspect of the disclosure.

FIG. 12 is a left rear perspective view of an example animal training and control device according to another aspect of the disclosure.

FIG. 13 is a right rear perspective view of the example animal training and control device of FIG. 12

FIG. 14 is a left rear perspective of the example animal training and control device of FIG. 12 showing example side shields installed.

FIG. 15 is an exploded view showing details of an example insert according to an aspect of the disclosure.

FIG. 16 is a side view showing the example animal training and control device of FIGS. 12-15 on a dog.

FIGS. 17A and 17B are side views showing the flexing of an example animal training and control device.

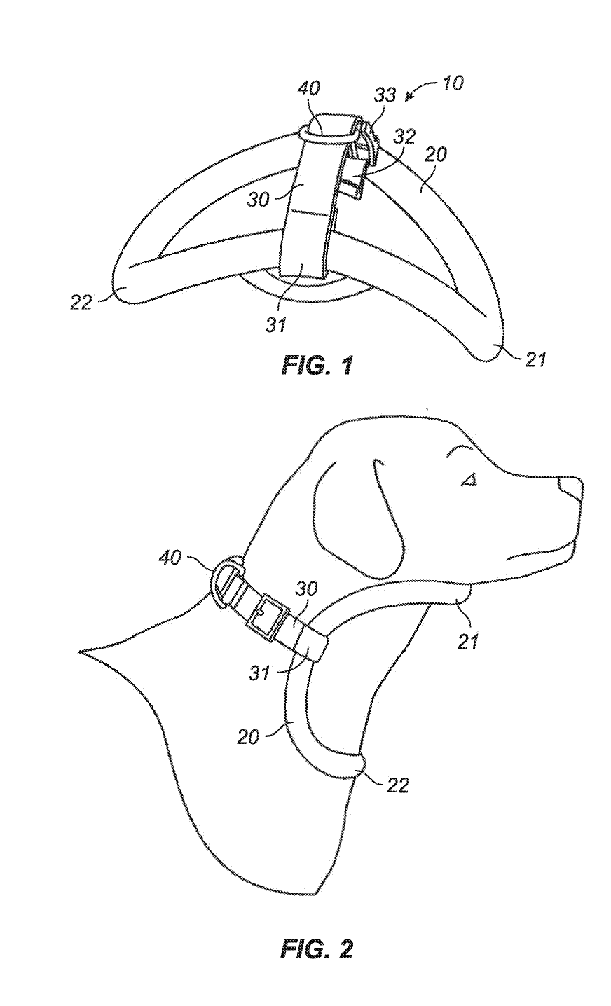

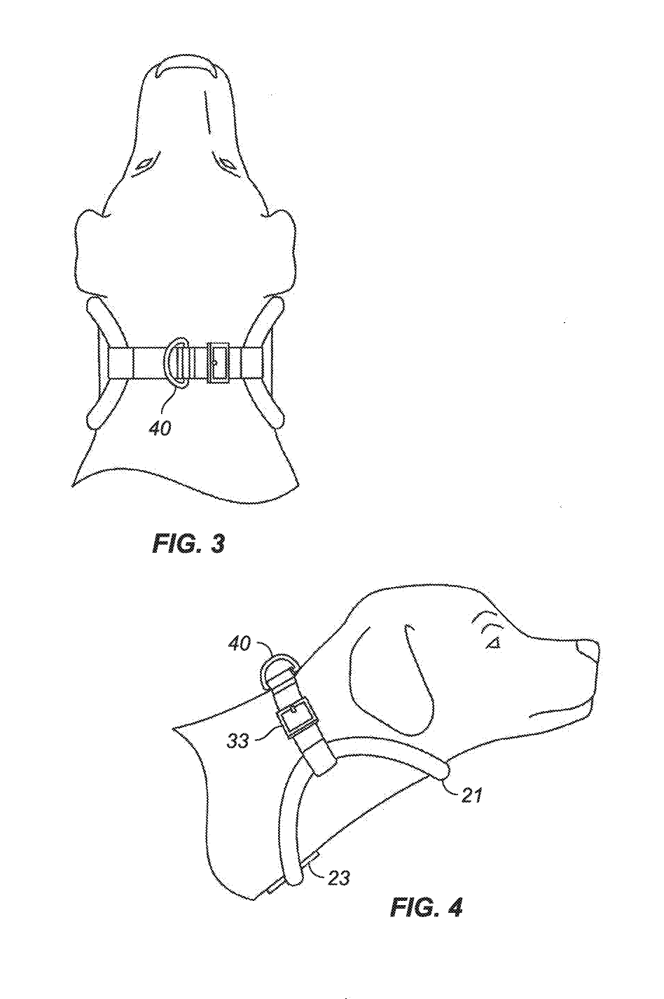

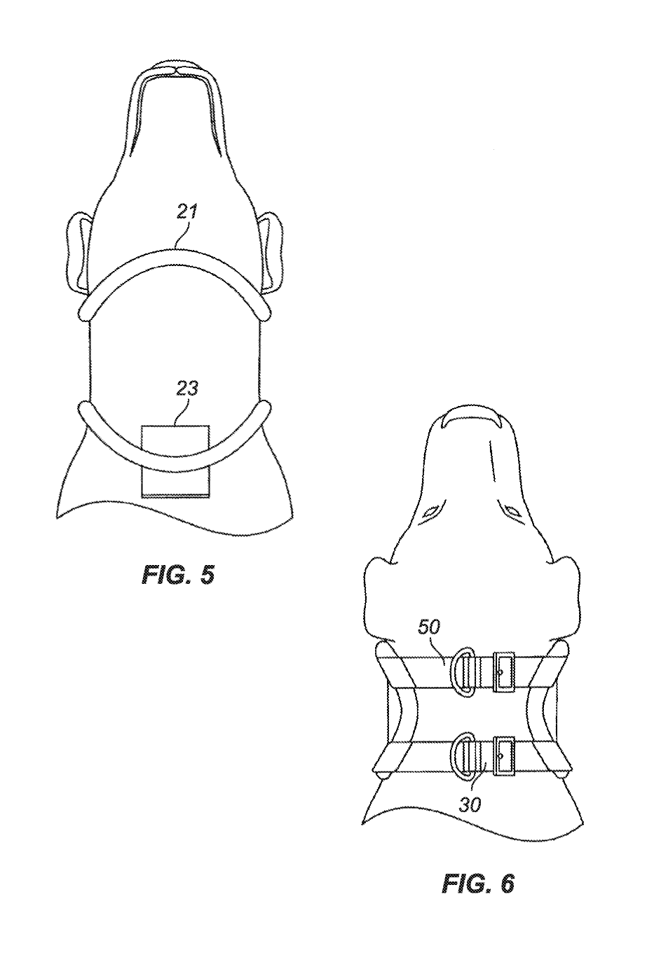

### DETAILED DESCRIPTION

Referring to the figures, a dog collar 10 according to one embodiment of the present invention generally includes an arched or curved substantially oval-shaped member 20, a strap 30 and a leash loop 40.

Member 20 includes a first end 21 and a second end 22. In use, first end 21 is positioned under the dog's chin. Member 20 extends up along each side of the dog's neck in an arched manner and continues down between the dog's shoulders such that second end 22 rests on the dog's upper chest. In one embodiment of the invention, second end 22 includes a flattened area 23 where it engages the animal's chest. This is more comfortable for the animal and provides a visual indication as to the proper orientation of collar 10.

The strap 30 has a first end 31 engaging one side of member 20 and a second end 32 engaging the opposite side. Ends 31 and 32 may be looped such that strap 30 is moveable along member 20. Alternatively, ends 31 and 32 may be fixed with respect to member 20. Ends 31 and 32 may be connected to member 20 by any suitable means, such as by stitching, adhesive or mechanical fasteners. Strap 30 further includes an adjustable buckle or clip 33 to allow for adjustment of collar 10 to comfortably fit animals of different sizes. Note also that the size of member 20 will vary depending on the size of the animal with which collar 10 will be used. A leash loop 40 is positioned on strap 30 as shown.

Collar 10 can be positioned on the dog either by loosening strap 30 sufficiently to permit strap 30 to be slid over the top of the dog's head and member 20 to be positioned beneath the dog as described above. Alternatively, buckle or clip 33 can be fully released, member 20 can be positioned beneath the dog and strap 30 can be wrapped around the dog's neck and secured with buckle or clip 33. Note that as positioned on the animal, the collar of the present invention does not overlap the dog's throat or trachea. Thus, pulling on the leash to control the dog's movement does not cause the dog to choke. Note also that member 20 engages each side of the dog's chin. This assists in controlling the dog during walking because it allows the handler to use the leash to move the dog's head and thereby influence the direction that the dog walks. For example, pulling the leash to the right will cause the member 20 to put pressure on the left side of the dog's neck, thereby tending to orient the dog's head toward the right. This encourages the animal to turn to the right. The opposite result is achieved by pulling the leash to the left.

FIG. 6 shows an alternative embodiment of the present invention that utilizes an additional strap 50. This embodiment is primarily intended for use with large, hard to control animals.

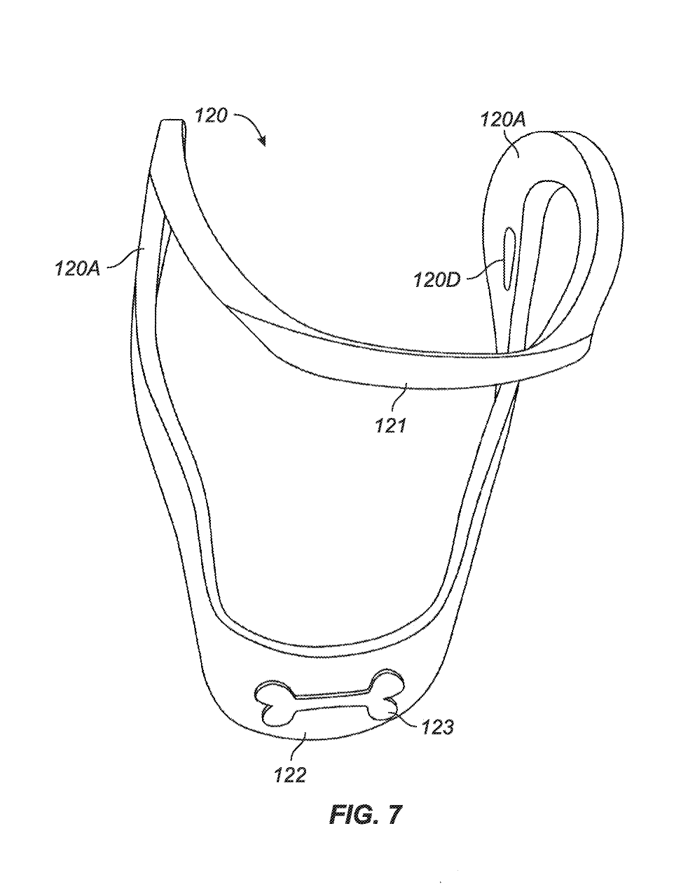

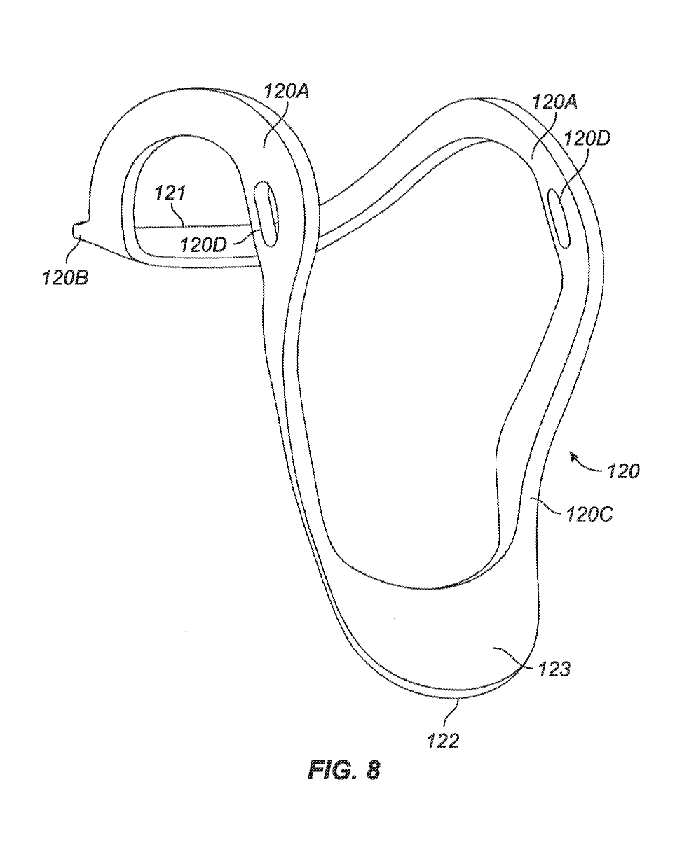

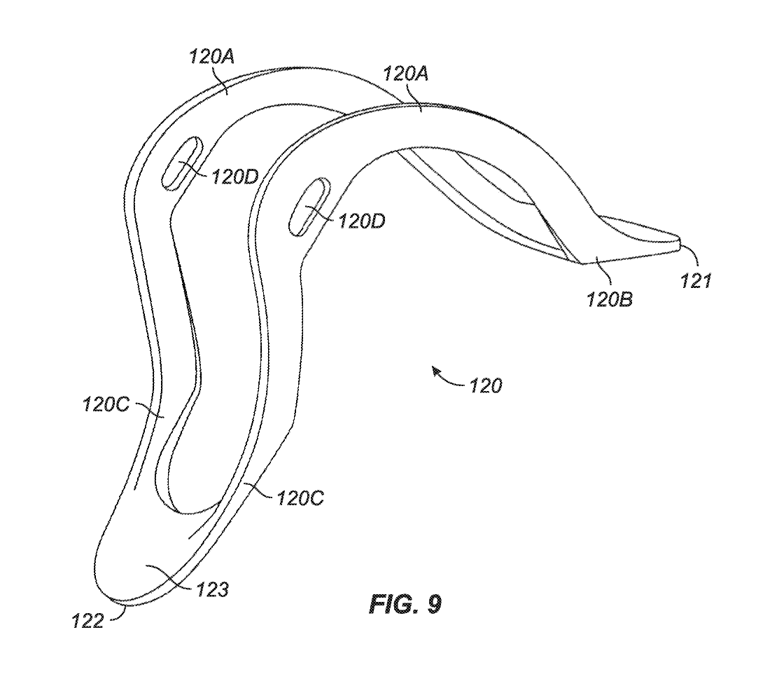

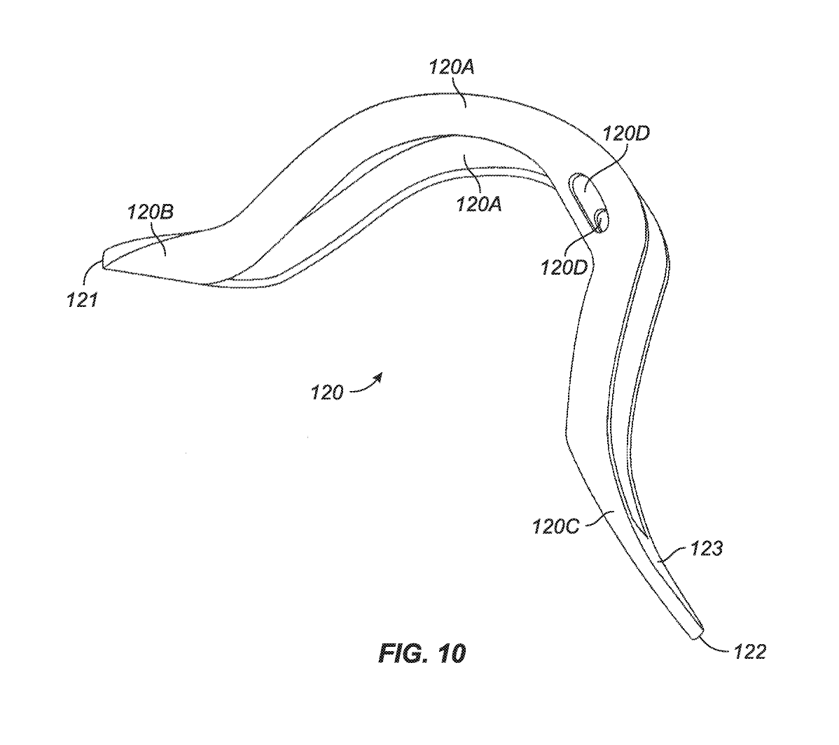

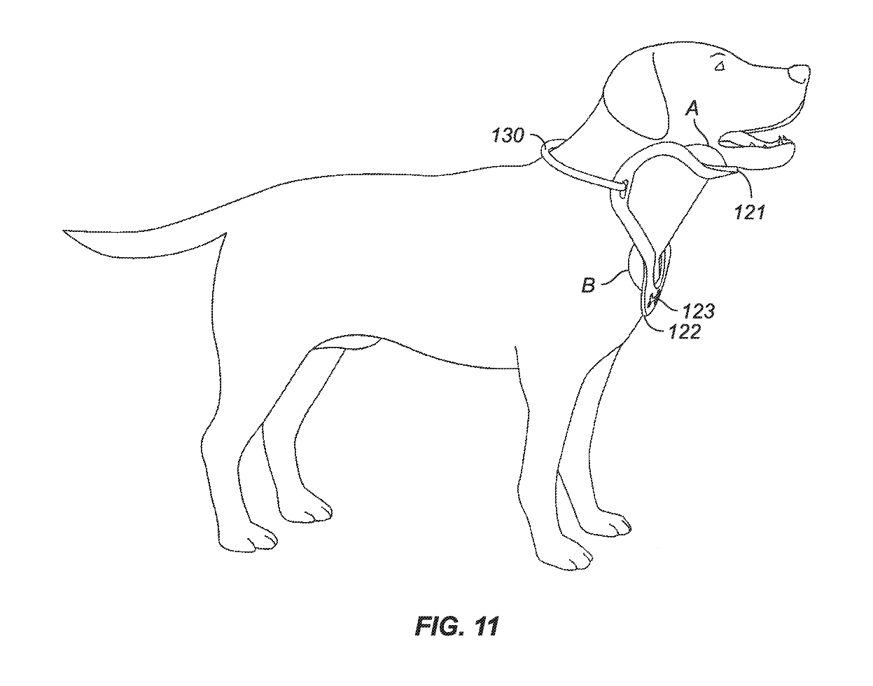

FIGS. 7-11 illustrate a dog collar according to another embodiment of the present invention. Dog collar 110 according to one embodiment of the present invention generally includes a first member 120 and a strap 130. Like member 20 above, member 120 is a substantially closed loop with a central open area.

Member 120 includes first or central sections 120A that are substantially curved or arched members. Second sections 120B are disposed at an angle A with respect to central section 120A. In the embodiment shown, angle A is approximately 135-40 degrees. First end 121 connects sections 120B on opposite sides. Third sections 120C are disposed at an angle B with respect to first sections 120A. In the embodiment shown, angle B is approximately 145-150 degrees. Angles A and B can be varied based on the size and build of the dog to ensure proper placement as described below. Second end 122 connects sections 120C on opposite sides. Member 120 includes a flat area 123 adjacent second end 122. A pair of openings or holes 120D are provided in sections 120A for receiving the ends of strap 130. A leash may be connected directly to strap 130. Alternatively, a leash loop may be provided on strap 130. Strap 130 may be adjustable and/or may include buckles or other connecting members to facilitate positioning the collar on the dog as described above.

In use, first end 121 is positioned under the dog's chin. Sections 120A extend up along each side of the dog's neck in an arched manner and continue down between the dog's shoulders such that second end 122 rests on the dog's upper chest.

Note that like the other embodiments described above, as positioned on the animal, the central open area of the collar is positioned over the dog's throat and trachea and no portion of the collar overlaps the throat or trachea. Thus, pulling on the leash to control the dog's movement does not cause the dog to choke. Note also that sections 120A engage each side of the dog's chin. This assists in controlling the dog during walking because it allows the handler to use the leash to move the dog's head and thereby influence the direction that the dog walks. For example, pulling the leash to the right will cause the member 20 to put pressure on the left side of the dog's neck, thereby tending to orient the dog's head toward the right. This encourages the animal to turn to the right. The opposite result is achieved by pulling the leash to the left.

The device of the present invention can be made from any materials suitable to permit the appropriate pressure to be applied to the animal for proper control. Members 20 and 120 are preferably relatively lightweight, substantially rigid members with only a moderate degree of flexibility. Members 20 and 120 may include a soft cloth or other covering to provide additional comfort to the animal Straps 30 and 130 can be produced from a wide variety of materials, including those presently used to produce commercially available dog collars.

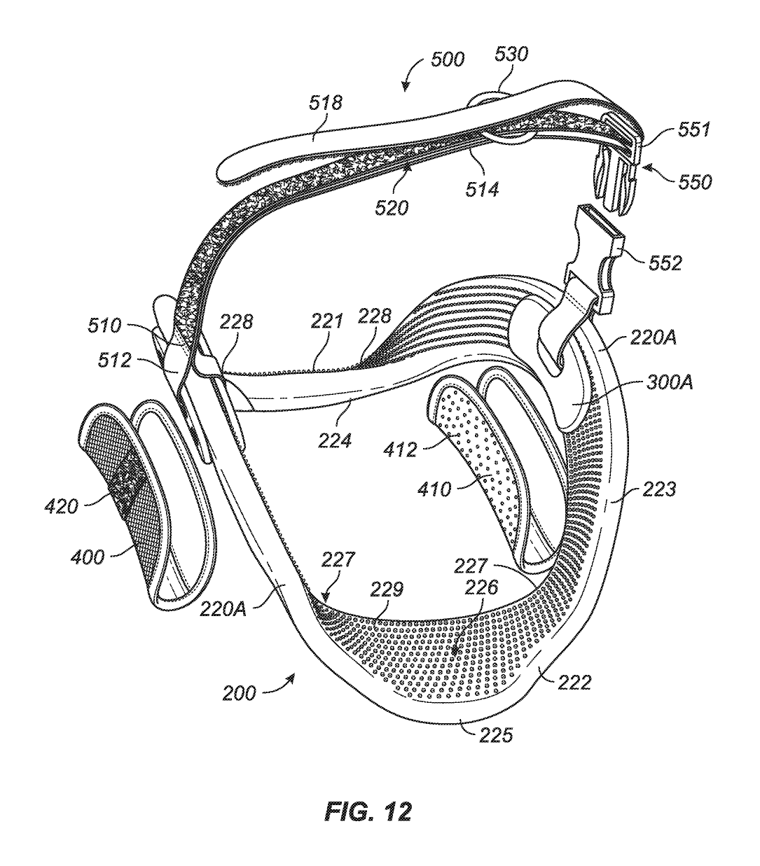

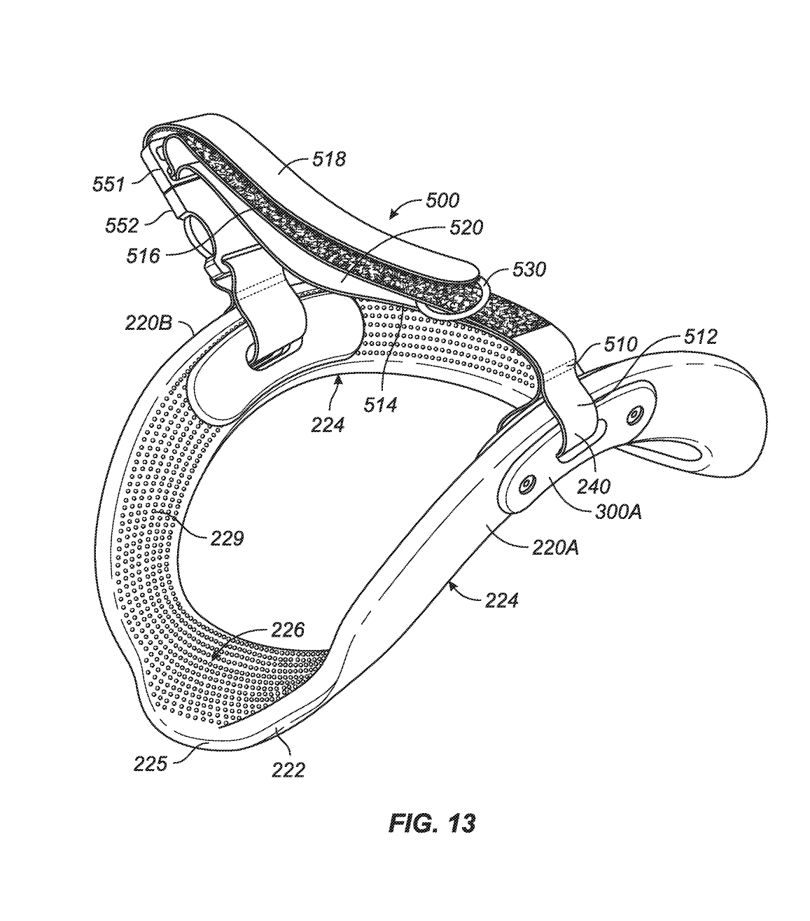

FIG. 12 is a perspective view of an example animal training and control device according to another aspect of the disclosure. The example device is generally referenced at 200. It may include an integrally molded or formed main body portion having a chest engaging section 222, neck engaging sections 220A and 220B extending from opposite ends of the chest engaging section, and a chin engaging section 221 extending between the neck engaging sections 220A and 220B. These sections may generally have a substantially uniform thickness and may be provided with a rounded upper/outer edge 223 extending around the main body and a rounded inner/lower edge 224. The rounded edges protect the animal and also result in a cross-section of the neck engaging section, chest engaging section and chin engaging section having desirable flexing qualities.

The neck engaging sections 220A and 220B, together with the chest engaging section 222 and chin engaging section 221 may define a continuous engaging surface 226 for engaging lateral areas of the animal's neck, chest and chin. The engaging surface 226 may be provided with a gripping pattern 229, which may include a number of small projections, such as bumps, tabs, buttons, stippling or other patterns formed in the engaging surface 226 for providing a secure yet comfortable fit of the device on the animal The gripping pattern 229 may help eliminate movement, such as rotation, of the device relative to the animal and keep the device securely in place against pulling, rotating or twisting forces that may arise then the device is utilized with a leash to train and control an animal.

According to an aspect of the disclosure, curved transitions 227 may be provided between the chest engaging section 222 and the neck engaging sections 220A and 220B. In addition, curved transitions 228 may be provided between the chin engaging section 221 and the neck engaging sections 220A and 220B. The curved transition 227 provide a contoured fit for the animal and also, as applicants have discovered, in combination with the orientation of the chest engaging section 222 and chin engaging section 221, provide for a pivoting movement of the neck engaging sections 220A and 22B relative to the chest engaging and chin engaging sections when a leash pulling force is applied to the main body. As will be described in more detail below, this pivoting action of the neck engaging sections provides a less dangerous and actually more therapeutic effect on the animal during control and training as the gentle clamping action of provided by the neck engaging sections 220A and 22B may have a calming effect on the animal as it mimics the interaction of mother animals in carrying their young by the neck.

The chest engaging section 222 may have a general plate shape and be provided with a chest engaging extension area 225 which increases the surface area applied to the animal's chest, where there is a high concentration of nerves, and also increases the relative stiffness of the chest engaging section 222, which in turn results in not only a more secure and comfortable fit, but also more firm application of control forces to the animal's chest with little or no flexing of the chest engaging section 222. The chest engaging section is generally larger than the chin engaging section in terms of the area contacting the animal and may be sized for an optimal fit and engagement with a given size dog. Moreover, the chest-engaging section 222 may have more rigidity relative to the chin engaging section, owing to geometry (width, thickness, length) as well as the material from which the chest engaging section is made. For example, the chin engaging section may have a reduced thickness compared to the chest engaging section to provide for comfort to and conformance with the animal in the chin area. The extra material and surface area of the chest engaging section provides more surface contact with the animal's skin/hair to increase gripping and prevent relative movement. The increased surface area provides for better control of the animal as more nerve endings are stimulated when a pulling force and resulting pressure on the animal's chest occur. This generally has a tendency to calm the animal down.

The neck-engaging sections 220A and 220B may have a generally arcuate shape. In addition, the chin-engaging section plane and the chest engaging section plane form an angle of about 117 degrees.

The main body may be molded or otherwise formed from a plastic material with suitable elasticity and shore hardness to achieve, in combination with the geometry of the main body, optimal durability, control, comfort and safety of the animal That is, the materials should provide sufficient flexibility to permit the desired pivoting/clamping action of the neck-engaging sections without impacting the strength of the device or firmness of the chest engaging section and chin engaging section.

As will be recognized, the thickness of the device chin, neck and chest engaging portions may be varied to achieve a desired balance of flexibility, comfort and control of a given size animal In addition, the hardness and elastic modulus of the material from which the device is formed, cast or otherwise made, may be selected to achieve this balance. Applicants have discovered that materials with a Shore hardness in the range of 65+/−3 may provide suitable balance of these parameters.

According to another aspect of the disclosure, the device 200 may be provided with stiffening elements 300A and 300B disposed at particular locations on the neck engaging sections 220A and 220B. Stiffening elements 300A and 300B may be made from a material, such as nylon, that is different from the material used for the main body and which is generally more rigid or stiff. The stiffening elements 300A and 300B function to prevent undue bending or deformation of the neck engaging sections 220A and 220B in a direction that is generally transverse to the extent of the neck engaging sections under leash pulling forces and to ensure continued comfort and control of the animal According to another aspect of the disclosure, the stiffening elements 300A and 300B may also function to reinforce attachment of the strap to the device.

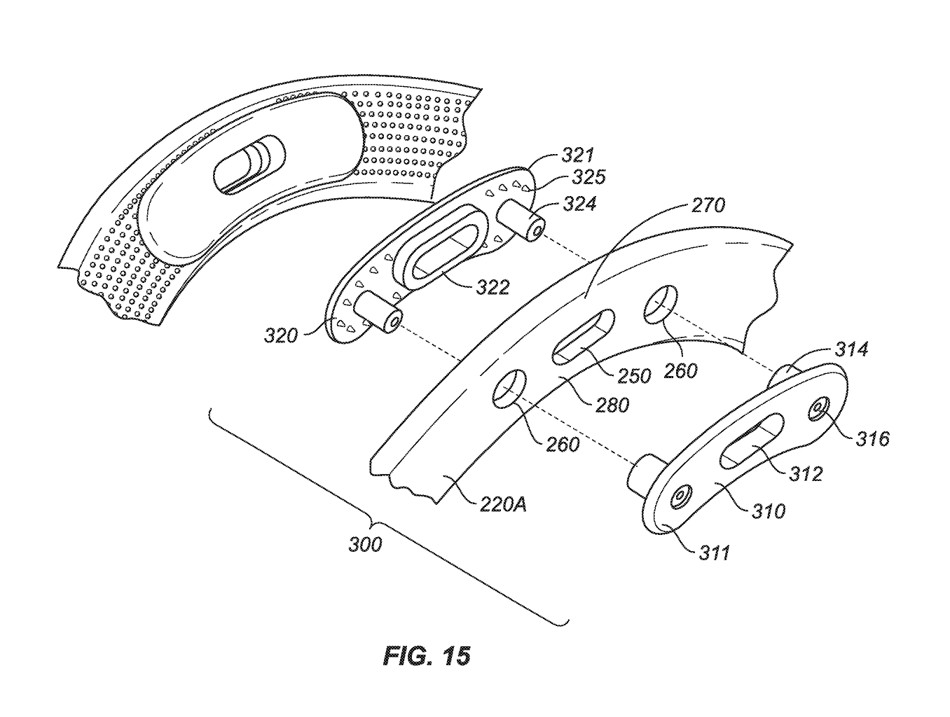

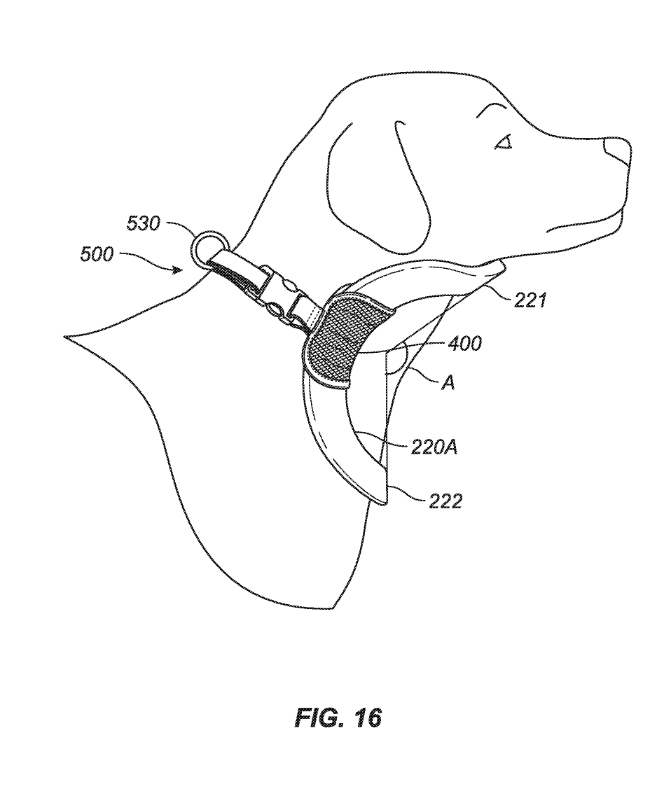

FIG. 15 is an exploded view of an example stiffening element 300 and attachment configuration. Neck engaging section 220A may be provide with a central strap attachment slot or hole 250 and a pair of stiffening element attachment holes 260. Stiffening element 300 may be assembled from two parts, a male section 320 and a female section 310 which are fastened in a clamped arrangement and secured to the neck engaging section 220A. Female section 310 may include a pair of extensions 314 correspondingly sized to the attachment holes 260 and adapted to receive corresponding projections 324 on the male section 310. Gripping or piercing projections 325 may be provided on one or both of the male and female sections to further secure the stiffening element 300 against movement. Slots 312 and 322 cooperate and extend into the hole 250 to reinforce the same for securing of a strap. Screws or other fasteners 316 may secure the male and female sections together in a clamping arrangement on the neck engaging section 220. FIG. 12 shows the stiffening inserts installed on both of the neck engaging sections 220A and 220B. Stiffening inserts 300A and 300B may receive and secure respective fastening straps 240A and 240B, which in turn, secure a main strap 230 to the device as will be explained.

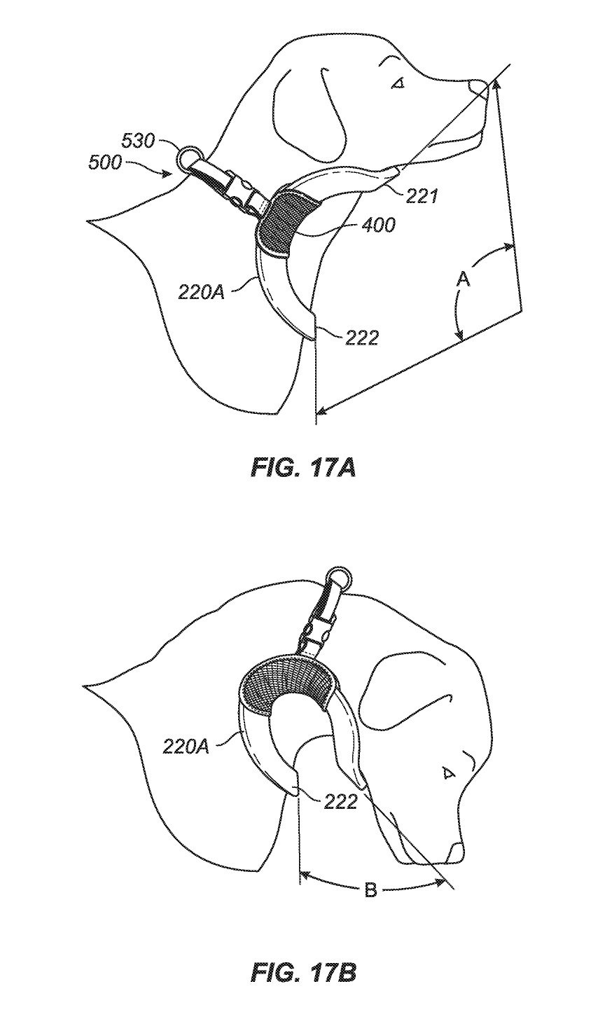

According to another aspect of the disclosure, the stiffening elements 300A and 300B also provide for improved flexing in the neck engaging sections generally within the plane of the neck engaging sections to permit movement of the animal's head relative to its body, while still exerting a firm force under the chin or jaw of the animal and maintaining lateral stability, i.e. no buckling at the center, of the neck engaging sections when the animal moves its head downward (see FIGS. 17A and 17B). As shown in FIG. 15, the stiffening elements 300A and 300B, and the slots or holes 250 and 260 divide the neck engaging sections into top portions 270 and bottom portions 280. These portions interact with the stiffening elements 300A and 300B to permit bending of the collar in a front-to-back direction and full range of motion of the animal, i.e., with top portions 270 stretching and bottom portions 280 compressing, enabling the device to flex as the head of the animal moves (as in FIGS. 17A and 17B), without buckling inward, i.e., squeezing the neck of the animal

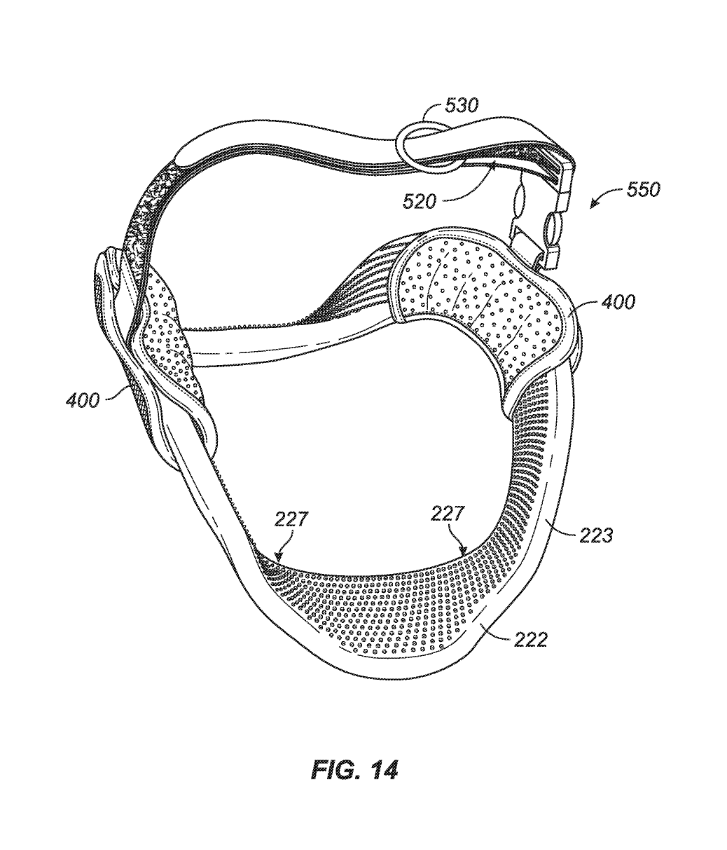

Referring to FIGS. 12 and 14, according to another aspect of the disclosure, side shields 400 are provided around the stiffening elements 300A and 300B to protect the animal and enhance comfort. FIG. 12 shows the side shields in an unassembled (unstitched) position and detached from the device 200. Side shields 400 may be made from a fabric material and may include a gripping pattern of plastic bumps or tabs 410 provided on an interior surface 412 to further ensure a secure fit on the animal An edge cover 414 may be provided for sealing and for further comfort. FIG. 14 illustrates the side shields 400 in an installed position after fastening the edges by sewing or other fastening techniques.

According to another aspect of the disclosure, the device may include a leash attachment system generally referenced as 500, which may be constructed of a flexible high strength material such as nylon fabric. One or more straps may be configured with stitching and releasable fasteners, such as hook-and-loop fasteners and quick release buckles or clasps to provide for adjustment as well as fastening of a leash to the device in a manner that eliminates or reduces movement of the device on the animal during control or training. More particularly, for example, the leash attachment system 500 may utilize a strap member 510 that is fed through one of the attachment apertures in the stiffening element and secured with a first fastener—in this example case stitching 510—to form a first attachment loop 512. Two strap sections 514 and 516 of the strap may extend to form a loop 520 which retains a leash attachment ring 530 for sliding movement therein. The two strap sections 514 and 516 may be fastened at ends opposite stitching 510 to form the loop 520. As shown in FIG. 13 fastening may be provided by feeding the sections 514 and 516 through a buckle 551 provided as part of a male portion 552 of a quick release fastener 550, the female portion 554 of which may be secured to the main body through a second fabric loop 562. Alternatively, the sections may be fastened by stitching at the opposite ends, such as stitching 510, to form the loop 520. The two sections 514 and 516 may extend together to form a doubled section 518, i.e. having a double thickness. The doubled section 518 may extend back over strap section 516 and secured thereto with hook-and-loop fastening fabric 540 to provide for adjustment of the strap.

As will be recognized, the attachment system provides for leash attachment using the attachment ring 530. The sliding movement of the attachment ring 530 within the loop 520 permits leash force to be applied to the device while minimizing the tendency of the device to rotate or move relative to the animal More particularly, for example, when the animal moves to an extreme sideways or lateral position relative to the owner, the ring 530 will be in a laterally disposed position within loop 520, for example, adjacent stitching 510 (FIG. 13) rather than remaining stationary at a central position relative to the strap. The leash force applied when the ring 530 is in this position will result in a lateral movement of the neck engaging section 220B against a lateral area (muscles) of the animal's neck, thus the device will exert lateral force on the animal rather than tending to rotate relative to the animal.

As will also be recognized, the attachment system 500 described above provides for a one-time adjustment of the device using the hook-and-loop fasteners for optimum fit on the animal and also permits rapid attachment and detachment of the device using the quick release fastener 550.

FIGS. 17A and 17B illustrate the flexing qualities of an example training and control device according to an aspect of the disclosure. The device may be fashioned such that in an undeformed or unflexed state on the animal, shown in FIG. 17A, there is an angle “A” of about 117 degrees formed by a plane extending thru the chin engaging section 221 and a plane extending thru the chest engaging section 222. However, the undeformed or unflexed angle may vary depending on the size and type of animal with which the device is used. This provides a firm but comfortable fit near the animal's chin and tends to encourage proper posture for the animal Referring additionally to FIG. 17B, the flexing qualities of the device may permit the animal to move its head to a downward (looking down) orientation with only slight resistance and with the neck engaging sections deforming, but retaining a generally arcuate or “C” shape, without buckling and permitting reduction of the angle “A” in FIG. 17A to the angle “B” in FIG. 17B. The proper flexibility of the device may be achieved by a variations of material thickness, plastic durometer and the geometry and material of the stiffening elements in the neck engaging sections.

Although the present invention has been shown and described in detail the same is to be taken by way of example only and not by way of limitation. Numerous changes can be made to the embodiments shown without departing from the scope of the invention. The present invention may be further modified within the spirit and scope of this disclosure. The application is, therefore, intended to cover any variations, uses, or adaptations of the invention using its general principles. Further, this application is intended to cover such departures from the present disclosure as come within known or customary practice in the art to which this invention pertains.

1. An animal training and control device comprising:
a chest-engaging section having a substantially flat chest-engaging surface;
first and second laterally opposed neck-engaging sections extending from opposite sides of the chest-engaging section;
a chin-engaging section extending between the neck engaging sections.

2. The device of claim 1, further comprising at least one stiffening element cooperatively associated with the neck-engaging sections for increasing the stiffness of the neck engaging sections.

3. The device of claim 2, wherein the stiffening members are disposed in apertures formed in the neck-engaging sections.

4. The device of claim 2, wherein the at least one stiffening element includes a passage for receiving a strap fastener.

5. The device of claim 2, wherein the at least one stiffening element is made from a material that is different from the material from which the neck-engaging sections are made.

6. The device of claim 2, where the stiffening element is disposed at a central location on the neck-engaging section.

7. The device of claim 2, where the neck-engaging sections have an arcuate shape and the stiffening element conforms to the arcuate shape of the neck-engaging sections.

8. The device of claim 2 where the at least one stiffening element comprises two sections fastened together with fasteners that extend through the neck-engaging sections.

9. The device of claim 2, wherein the at least one stiffening element prevents buckling of the neck engaging sections when the animal moves its head downward.

10. The device of claim 4, further comprising at least one side shield covering the stiffening element.

11. The device of claim 10, wherein the at least one side shield is made from fabric.

12. The device of claim 10, wherein the side shield includes a gripping pattern on an interior surface thereof.

13. The device of claim 1, wherein the chest engaging section, neck engaging sections and chin-engaging section are formed as an integral, unitary piece.

14. The device of claim 1, further comprising a strap extending between the neck-engaging sections.

15. The device of claim 14, wherein the strap includes a loop and a leash fastening ring secured within the loop for lateral sliding movement therein.

16. The device of claim 15 further comprising a quick-release clasp for securing the strap between the neck-engaging sections.

17. The device of claim 1, wherein at least one of the neck-engaging sections, chest-engaging section and chin-engaging section are provided with a gripping pattern formed on a neck-engaging surface thereof.

18. The device of claim 1, further comprising curved transitions extending between the neck-engaging sections and the chest engaging section, and between the neck-engaging sections and the chin-engaging section such that the neck-engaging sections pivot inward to apply gentle lateral pressure to the animal's neck when a pulling force is applied to the device.
